(19) United States
(12) Patent Application Publication
(10) Pub. No.: US 2025/0022040 A1
(43) Pub. Date: Jan. 16, 2025

(54) ORDER AUTOMATIC INTERCEPTION METHOD AND SYSTEM

(71) Applicant: SHENZHEN MEIYUNJI NETWORK TECHNOLOGY CO., LTD, ShenZhen (CN)

(72) Inventors: Zhichao WANG, ShenZhen (CN); Songhui Mei, ShenZhen (CN); Feng Zeng, ShenZhen (CN); Zhen Wang, ShenZhen (CN); Zhijie Yang, ShenZhen (CN); Shoubao Chen, ShenZhen (CN)

(73) Assignee: SHENZHEN MEIYUNJI NETWORK TECHNOLOGY CO., LTD, ShenZhen (CN)

(21) Appl. No.: 18/769,382

(22) Filed: Jul. 10, 2024

(30) Foreign Application Priority Data
Jul. 12, 2023 (CN) 202310849559.0

(51) Int. Cl. G06Q 30/0601; G06Q 10/087

(52) U.S. Cl. CPC G06Q 30/0635; G06Q 10/087

(57) ABSTRACT

An order automatic interception method and a system. The method includes: obtaining a data access authority of a corresponding store of an e-commerce platform, setting a monitoring rule for order information; collecting order information of the corresponding store from the e-commerce platform, storing order information of a corresponding order to the e-commerce ERP database for a first time; synchronizing order information at a time interval T1, storing order information of the e-commerce platform to the e-commerce ERP database each time the order information is synchronized; and determining whether the monitoring information of the e-commerce ERP database is consistent with the corresponding order information of the e-commerce platform, performing interception processing an order with inconsistent order information in response to that the monitoring information of the e-commerce ERP database is inconsistent with the corresponding order information of the e-commerce platform through the order interception unit.

### TECHNICAL FIELD

The present application relates to the technical field of computers, and in particular to an order automatic interception method and a system thereof.

### BACKGROUND

With the rise of global e-commerce, international retail trade has developed rapidly, and a large number of domestic small and medium-sized e-commerce sellers have expanded their retail business to foreign markets. With the development of cross-border business, the e-commerce ERP system developed based on ERP software have gradually developed. E-commerce ERP can be deeply connected with e-commerce platforms to help domestic small and medium-sized e-commerce sellers manage their overseas stores in a unified manner, which can avoid the obstacles caused by language differences, and enable one operator to manage hundreds of e-commerce stores at the same time, thereby greatly improving the efficiency of store operations.

E-commerce ERP accesses and controls stores on e-commerce platforms through established rules, and processes dynamic data in all links during store operations. There is a complex data management. In addition, the operational convenience requirements of various types of users (sellers) should be met. Therefore, the various functional modules of existing commercialized e-commerce ERP are still in the stage that the functions are gradually updated and improved. The functional algorithms and rules formulated by various software companies when software companies develops their own e-commerce ERP are different. Each functional module will continue to develop new versions with the changes of user need, to be compatible with more usage scenarios.

For the store products that have been released, orders can be processed in batches through e-commerce ERP. However, in the order execution stage, due to the possibility of bugs in the e-commerce platform, abnormal API interfaces or other uncontrollable factors, sellers may make mistakes in picking and delivering, which may lead to a series of problems such as logistics rejection and customs declaration interception, causing great losses to sellers. Although the probability of such errors is very low, and these errors have characteristics of occasionality, invisibility, short-lasting, and restorability, the losses are great after the errors occur, and it is difficult to find the real cause of the order execution error, and it is difficult to require the e-commerce platform to bear the corresponding responsibility.

In addition, some e-commerce platforms will provide customized functional services, and some regional small and medium-sized e-commerce platforms have not been in operation for a long time, resulting in volatile data on e-commerce platforms and a significant increase in the probability of data errors. Moreover, in the order execution stage, if the product information changes, it may further cause the products purchased by the buyer to be inconsistent with the actual products delivered, resulting in the wrong products being delivered. The existing e-commerce ERP has not considered and solved these issues, which brings a lot of uncertainty of order processing.

Other technical problems related to the present application will be further described later. The above contents are only used to understand the technical solution of the present application, and it does not mean that all of the above contents are included in the prior art.

### SUMMARY

The main purpose of the present application is to provide an order automatic interception method and a system, to avoid order losses due to abnormal order data in the order execution link and improve the security of order processing.

To achieve the above purpose, the present application proposes an order automatic interception method applied to the order management module of the e-commerce ERP. The order management module includes an order list and an order interception unit. The method includes following steps.
obtaining a data access authority of a corresponding store of an e-commerce platform, setting a monitoring rule for order information, the monitoring rule being configured for the order management module to monitor corresponding order information, monitored order information being configured as monitoring information;
collecting order information of the corresponding store from the e-commerce platform, storing order information of a corresponding order to the e-commerce ERP database for a first time, and displaying the order information in the order list;
synchronizing order information at a time interval T1, storing order information of the e-commerce platform to the e-commerce ERP database each time the order information is synchronized, and displaying latest order information in the order list; and
determining whether the monitoring information of the e-commerce ERP database is consistent with the corresponding order information of the e-commerce platform, terminating synchronization of this order information in response to that the monitoring information of the e-commerce ERP database is consistent with the corresponding order information of the e-commerce platform, and performing interception processing an order with inconsistent order information in response to that the monitoring information of the e-commerce ERP database is inconsistent with the corresponding order information of the e-commerce platform through the order interception unit, and marking an intercepted order as intercepted in the order list.

This order automatic interception method and the corresponding system can make up for the defects of the e-commerce platform caused by unstable system data, data update errors, changes in product information during the order execution stage, and the like, thereby avoiding order execution errors, and order losses caused by abnormal order data in the order execution stage, and improving the security of order processing. In addition, the stability of the e-commerce ERP system can be improved, so that the e-commerce ERP system can be compatible with more e-commerce platforms, including new small and medium-sized e-commerce platforms. When an order is lost due to the e-commerce platform, the relevant evidence stored in the e-commerce ERP database can be used to claim compensation for losses from the corresponding e-commerce platform to improve the safety of store operations.

Other implementation plans and technical effects are described later.

Further, the present application also provides a system, which includes functional modules such as a product module, a sales module, a procurement module, a logistics module, a warehouse module, a financial module, an advertising module, a customer service module or a tool module, and various operation instructions for executing corresponding functional modules. Correspondingly, the present application also provides a server, which includes a memory and a processor. The functional modules and the system in the present application are stored in the memory, and the processor can execute the operation instructions of the corresponding functional modules and the system. In addition, the present application also provides a computer device, which includes a memory and a processor. The functional modules and the system of the present application are stored in the memory, and the processor can execute operation instructions of the corresponding functional modules and the system.

Statement, as shown in FIG. 1, the e-commerce ERP system of the present application includes one or more functional modules, such as commodity module, sales module, procurement module, logistics module, warehouse module, financial module, advertising module, customer service module, tool module, authority management module and data module. Each functional module of the present application can be integrated with each other, or can exist independently, or one functional module can be a sub-module of another functional module. Each functional module of the present application can be set on an e-commerce platform to manage the stores of the corresponding e-commerce platform. The operating personnels of the e-commerce ERP in the present application may further be called store managers, sellers, merchants, operators, operators, users, customer service personnel or questioners (questioners of the AI system). Unless otherwise stated, their identities are not strictly limited. In the present application, “products” and “products” are customary names in this field, and the two have the same meaning and are not distinguished. In the present application, when editing or creating product information, “fill out” and “fill” have the same meaning and are not distinguished. In the present application, “e-commerce platform” is the abbreviation of “e-commerce platform system”.

Meaning and explanation of terms in the e-commerce field in the present application are illustrated as follows (letters of English words in the present application are not case-sensitive).

(1) enterprise resource planning (ERP) refers enterprise resource planning, which can further be used as the abbreviation of ERP system in the present application.

(2) stock keeping unit (SKU) refers to the inventory product code, which generally refers to the product represented by the product number.

(3) application programming interface (API) refers to the application programming interface, and further refers to as API interface in the present application. Bug refers to a system failure. ID refers to a character string of corresponding information, which is used to identify variables, functions, objects, storage addresses or other program elements of corresponding information in computer programming. In the present application, “ID” can be expressed as “ID character string”.

### BRIEF DESCRIPTION OF THE DRAWINGS

The accompanying drawings are used to provide further understanding of the present application and do not constitute a limitation to the present application. The contents shown in the accompanying drawings may be real data of the embodiments and shall fall within the scope of the present application.

FIG. 1 is a schematic diagram of functional modules in the e-commerce ERP system according to an embodiment of the present application.

FIG. 2 is a schematic flowchart of the store product order processing according to an embodiment of the present application.

FIG. 3 is a schematic structural diagram of the order management module according to an embodiment of the present application.

FIG. 4 is a schematic flowchart of the order automatic interception method flow according to an embodiment of the present application.

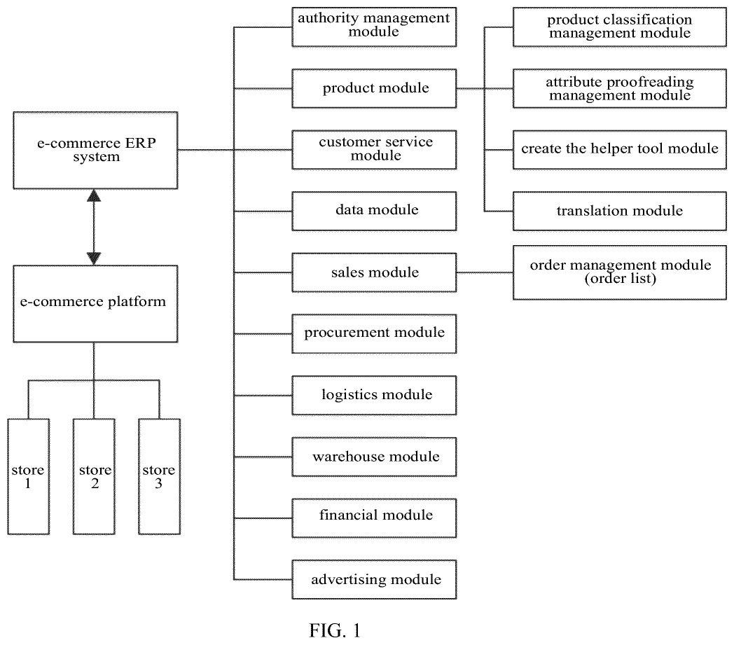

### DETAILED DESCRIPTION OF THE EMBODIMENTS

In order to make the purpose, technical solution and advantages of the present application clearer, embodiments of the present application are further described in detail through specific implementation methods in combination with the accompanying drawings. It should be understood that the specific embodiments described herein are only used to explain the present application and are not used to limit the present application.

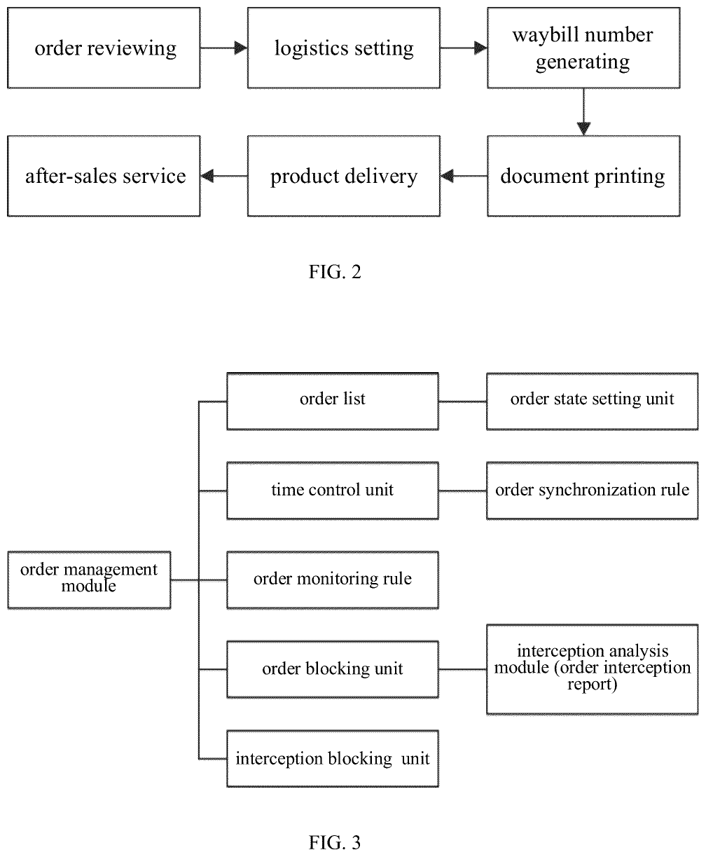

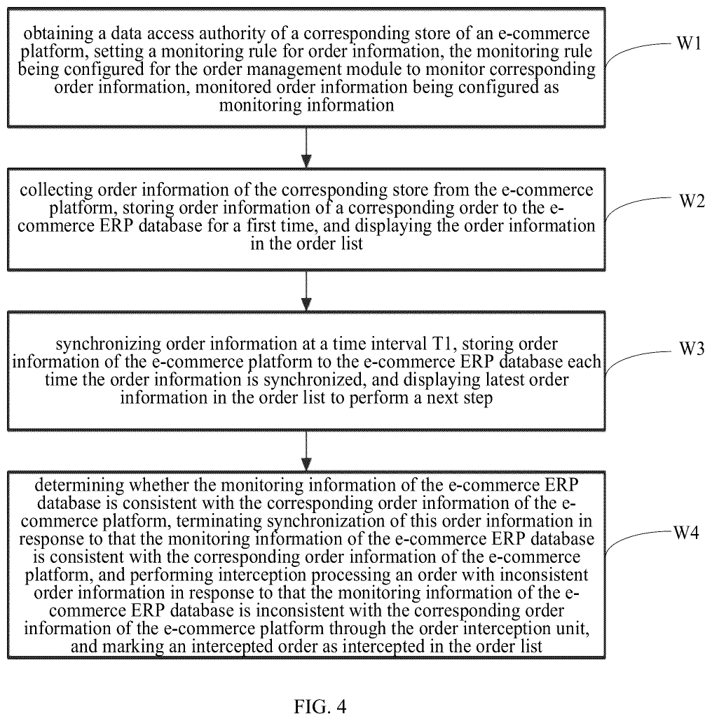

As shown in FIG. 2 to FIG. 4, the present application provides an order automatic interception method, applied to the order management module of the e-commerce ERP. The order management module includes an order list and an order interception unit, and the method includes steps W1-W4.

Step W1, obtaining the data access authority of the corresponding store of the e-commerce platform, setting the monitoring rules of the order information (that is, the order monitoring rules). The monitoring rules are configured for the order management module to monitor the corresponding order information, and the monitored order information is defined as monitoring information.

Step W2, collecting the order information of the corresponding store from the e-commerce platform, storing the order information of the corresponding order in the e-commerce ERP database for the first time, and displaying the order information in the order list.

Step W3, synchronizing the order information at the time interval T1, updating the order information of the e-commerce ERP to the order information of the e-commerce platform of the corresponding time, storing the order information of the e-commerce platform to the e-commerce ERP database each time the order information is synchronized, displaying the latest order information in the order list.

Step W4, determining whether the monitoring information of the e-commerce ERP database is consistent with the corresponding order information of the e-commerce platform, when the monitoring information of the e-commerce ERP database is consistent with the corresponding order information of the e-commerce platform, terminating the synchronization of this order information, when the monitoring information of the e-commerce ERP database is inconsistent with the corresponding order information of the e-commerce platform, intercepting the order with inconsistent order information by the order interception unit, and marking the intercepted order as intercepted in the order list, to wait for further verification and processing by the store operator. In the implementation, the interception mark can be automatically marked in the order list, and the relevant interception mark can be red text or symbol to make the intercepted order easier to identify.

Further, the order management module further includes an unblocking unit, and the intercepted order can be unblocked by the unblocking unit. When the intercepted order is unblocked, the corresponding intercepted order can be manually selected from the order list. The order state is set to cancel interception, so as to unblock the order. The normal operation authority of the order is restored, to allow to deliver normally.

In addition, the order list is provided with an order state setting unit, and the order interception state can be manually switched by the order state setting unit. That is, by selecting the corresponding order from the order list, the intercepted order can be set to the cancel interception state, or the unblocked order can be directly set to the intercepted state. For example, when the operator evaluates that the order does not need to be intercepted, the order interception can be manually unblocked. When the operator evaluates that the order needs to be intercepted, the corresponding order interception can be manually set, making the order interception and unblocking operations more convenient.

In the relevant embodiment, the monitoring information includes sub-order information, such as product SKU information, order amount information, order product quantity, order recipient information, and the like. The product SKU information includes product information, such as product title information, product attribute information, product image information, and the like. The product SKU information does not include product description information. After the buyer places an order, if an e-commerce platform information is pushed by mistake, the order is canceled, the order is refunded, or the e-commerce product information is updated, then the order information in the e-commerce ERP may be inconsistent with the order information when the buyer originally placed the order, thereby bringing risks to the order execution. Therefore, by setting the monitoring information, the order management module can automatically monitor these key monitoring information.

Each time the order information is stored in the e-commerce ERP database, a corresponding ID is first generated for the corresponding order information (that is, the ID is the string information of the corresponding order information, or the ID is the string of the corresponding order information, the corresponding storage address and other information), and then the ID of the corresponding order information is recorded in the e-commerce ERP database. When determining whether the monitoring information of the e-commerce ERP database is consistent with the corresponding order information of the e-commerce platform, the ID of monitoring information of the e-commerce ERP database is matched with the ID of the corresponding order information of the e-commerce platform. If the ID of monitoring information of the e-commerce ERP database is consistent with the ID of the corresponding order information of the e-commerce platform, then the monitoring information of the e-commerce ERP database is determined to be consistent with the corresponding order information of the e-commerce platform. If the ID of monitoring information of the e-commerce ERP database is inconsistent with the ID of the corresponding order information of the e-commerce platform, then the monitoring information of the e-commerce ERP database is determined to be inconsistent with the corresponding order information of the e-commerce platform. In this way, checking and verifying different types of text and/or pictures in the order information can be avoided, thereby improving the speed and accuracy of determining the consistency of the monitoring information, and saving the storage space for storing the monitoring information.

In the implementation, multiple e-commerce ERP monitoring information to be determined for consistency can generate a total ID, and multiple e-commerce platform order information to be determined for consistency can generate another total ID, and then the corresponding two total IDs are matched to determine whether the total IDs are the same, or each order information (that is, sub-order information) of the same order can generate corresponding IDs, and each monitoring information can generate corresponding IDs, and then ID matching can be performed on the same type of order information in the same order to determine whether the IDs of each monitoring information and the corresponding sub-order information are the same. The same ID indicates that the two matched order information are the same or consistent.

Further, each time the order information is stored in the e-commerce ERP database, the storage time of the corresponding order information is marked to trace and calculate the time of the order abnormality. In addition, when the monitoring information of the e-commerce ERP database is inconsistent with the corresponding order information of the e-commerce platform, all order information involved in the intercepted order (including all product information of the order product) will be stored in the e-commerce ERP database as an attachment.

The order interception unit includes an interception analysis module. In step W4, when the monitoring information of the e-commerce ERP database is inconsistent with the corresponding order information of the e-commerce platform, the interception analysis module extracts the IDs of all monitoring information of the e-commerce ERP database and monitoring information with different IDs from corresponding order information of the e-commerce platform, intercepts and analyzes extracted monitoring information, and generates an order interception report based on the extracted monitoring information. All the extracted monitoring information is displayed in the order interception report, and a reason for the order being intercepted is that corresponding monitoring information is abnormal is explained (for example, when the extracted monitoring information includes product SKU information, it is explained in the order interception report that the product SKU information of the intercepted order is abnormal. When the extracted monitoring information includes order recipient information, it is explained in the order interception report that the order recipient information of the intercepted order is abnormal), and time when the order is intercepted is recorded as time when the monitoring information is abnormal in the order interception report.

The order interception report can be displayed in the order details page of the order list, and the order details page can further display the execution progress of the corresponding order. In other embodiments, the interception analysis module counts the number and amount of each intercepted order as a reference for store operation risks. The number and amount of orders intercepted due to the e-commerce platform (for example, excluding manually intercepted orders and orders automatically intercepted due to returned products or exchanged products) are used as the basis for evaluating the stability of the e-commerce platform, and the order information stored in the e-commerce ERP database can be used as evidence to require compensation from the e-commerce platform, thereby improving the safety of store operations.

In one embodiment, after the order is intercepted, the synchronization of the order information of the intercepted order is terminated, and the corresponding order is synchronized again after the interception is relieved. In another embodiment, after the order is intercepted, the order information of the intercepted order is synchronized at the time interval T1 to determine whether the monitoring information of the order when being intercepted is consistent with the latest order information of the e-commerce platform. When the monitoring information of the order when being intercepted is consistent with the latest order information of the e-commerce platform, the order management module automatically unblocks the order, so that after the e-commerce platform system restores the correct order information, the e-commerce ERP system can correspondingly unblock the order.

Further, in step W3, when the order management module synchronizes the order information at the time interval T1, if the returned data of the order information obtained from the e-commerce platform is empty, it is determined that the synchronization of the order information fails, and synchronization failure of the corresponding order information is prompted in the order list to inform the store operator of the abnormity.

Further, the order interception unit monitors the order state of the corresponding order each time the order information is synchronized, and when the latest order state of the corresponding order is product returned or product exchanged, the order for product returned or product exchanged will be intercepted.

Further, in step W4, the performing interception processing includes intercepting and processing a corresponding interception order in one or more links during waybill number generation, unit price printing, and commodity delivery, so as to prohibit the intercepted order from performing corresponding operations in the relevant interception processing links, or generating corresponding order interception prompts in the relevant interception processing links.

As shown in FIG. 2, on the e-commerce ERP system, the order processing process includes eight order execution links, such as order reviewing, logistics setting, waybill number generation, document printing, commodity delivery and after-sales service. In the order reviewing stage, the operator can check the list requirements, including order products, buyer messages and other information, and check whether to accept the order. In the logistics setting stage, the operator fills in the customs declaration information, selects the logistics method, applies for the waybill number and other operations. In the waybill number generation stage, the waybill number is generated according to the order information and customs declaration information submitted to the logistics provider system, and the corresponding order is transferred to the document printing stage after the waybill number is generated. In the document printing stage, the printing of the product picking list and the delivery list is completed. In the product delivery stage, the picking and delivery of the products are completed. In the after-sales service stage, the order of products returned, products exchanged, customer care, satisfaction survey and other operations are performed. After the order is intercepted and processed, when the intercepted order generates a picking list and/or a delivery list, the prompt information that the order or the order products is intercepted will be marked on the generated picking list and/or delivery list to remind the relevant personnel to pay attention to and verify the actual order information.

Further, the order management module further includes a time control unit, which executes the step W3, synchronizing order information at the time interval T1. The synchronization mode of the order information is to set the corresponding automatic synchronization mode for different stores of the e-commerce platform. Some stores of the e-commerce platform are automatically synchronized at a certain time interval T1, and other stores of the e-commerce platform are synchronized in real time, so as to facilitate the operators to flexibly set the order synchronization time for different types of stores, so that orders of stores with higher priority can be synchronized in advance during the peak order period, and to process orders of different delivery cycles separately. In the implementation, the order information can be synchronized by setting order synchronization rules. Or the order information can be synchronized manually. When the manual synchronization is performed manually (it can be clicking the manual synchronization button of the order list), the order management module immediately executes the step W3.

The above descriptions are only some embodiments of the present application, and does not limit the scope of the present application. Under the inventive concept of the present application, all equivalent transformations made by using the contents of the specification and drawings of the present application, or directly/indirectly applied in other related technical fields, shall fall within the scope of the present application.

What is claimed is:

1. An order automatic interception method, applied to an order management module of e-commerce enterprise resource planning (ERP), wherein the order management module comprises an order list and an order interception unit, and the method comprises:
obtaining a data access authority of a corresponding store of an e-commerce platform, and setting a monitoring rule for order information, wherein the monitoring rule is configured for the order management module to monitor corresponding order information, monitored order information is configured as monitoring information, and the monitoring information comprises product stock keeping unit (SKU) information, order amount information, an order product quantity, order recipient information;
collecting order information of the corresponding store from the e-commerce platform, storing order information of a corresponding order to the e-commerce ERP database for a first time, and displaying the order information in the order list;
synchronizing order information at a time interval T1, storing order information of the e-commerce platform to the e-commerce ERP database each time the order information is synchronized, and displaying latest order information in the order list; and
determining whether the monitoring information of the e-commerce ERP database is consistent with the corresponding order information of the e-commerce platform, terminating synchronization of this order information when the monitoring information of the e-commerce ERP database is consistent with the corresponding order information of the e-commerce platform, and performing interception processing an order with inconsistent order information in response to that the monitoring information of the e-commerce ERP database is inconsistent with the corresponding order information of the e-commerce platform through the order interception unit, and marking an intercepted order as intercepted in the order list.

2. The order automatic interception method according to claim 1, wherein the order management module further comprises an unblocking unit, the intercepted order is unblocked by the unblocking unit, and the method further comprises:
when the intercepted order is unblocked, manually selecting a corresponding intercepted order from the order list, and configuring the order state to cancel interception.

3. The order automatic interception method according to claim 2, wherein the order list is provided with an order state setting unit, and the method further comprises:
manually switching an order interception state through the order state setting unit.

4. The order automatic interception method according to claim 1, wherein the product SKU information comprises product title information, product attribute information, and product image information.

5. The order automatic interception method according to claim 4, further comprising:
generating a corresponding ID for the corresponding order information and recording the ID of the corresponding order information in the e-commerce ERP database each time the order information is stored in the e-commerce ERP database;
matching the ID of monitoring information of the e-commerce ERP database with the ID of the corresponding order information of the e-commerce platform in response to determining whether the monitoring information of the e-commerce ERP database is consistent with the corresponding order information of the e-commerce platform;
when the ID of corresponding monitoring information of the e-commerce ERP database is consistent with the ID of the corresponding order information of the e-commerce platform, determining the monitoring information of the e-commerce ERP database to be consistent with corresponding order information of the e-commerce platform; or
when the ID of corresponding monitoring information of the e-commerce ERP database is inconsistent with the ID of the corresponding order information of the e-commerce platform, determining the monitoring information of the e-commerce ERP database to be inconsistent with corresponding order information of the e-commerce platform.

6. The order automatic interception method according to claim 5, wherein the order interception unit comprises an interception analysis module, and the method further comprises:
when the monitoring information of the e-commerce ERP database is inconsistent with corresponding order information of the e-commerce platform, extracting, via the interception analysis module, IDs of all corresponding order information of the e-commerce platform and monitoring information with different IDs from corresponding order information of the e-commerce platform, intercepting and analyzing extracted monitoring information, and generating an order interception report based on the extracted monitoring information; and
displaying all the extracted monitoring information in the order interception report, and explaining a reason for the order being intercepted is that corresponding monitoring information is abnormal, and recording time when the order is intercepted as time when the monitoring information is abnormal in the order interception report.

7. The order automatic interception method according to claim 5, further comprising:
after intercepting the order, synchronizing order information of the intercepted order at the time interval T1, and determining whether the monitoring information of the order when being intercepted is consistent with latest order information of the e-commerce platform; and
when the monitoring information of the order when being intercepted is consistent with latest order information of the e-commerce platform, automatically releasing interception of the order through the order management module.

8. The order automatic interception method according to claim 1, further comprising:
when the order management module synchronizes order information at the time interval T1, in response to that data returned from the e-commerce platform is empty, prompting synchronization failure of corresponding order information in the order list; and/or
monitoring, via the order interception unit, an order state of the corresponding order every time order information is synchronized, and in response to that a latest order state of a corresponding order is returned or exchanged, intercepting a returned order or an exchanged order; and/or
performing interception processing comprises intercepting and processing a corresponding interception order in one or more links during waybill number generation, unit price printing, and commodity delivery.

9. The order automatic interception method according to claim 1, wherein:
the order management module comprises a time control unit, and the time control unit executes synchronization of order information at the time interval T1,
a synchronization mode of order information is configured to set a corresponding automatic synchronization mode for different stores of the e-commerce platform, some stores of the e-commerce platform are automatically synchronized at a certain time interval T1, and other stores of the e-commerce platform are synchronized in real time; or
a synchronization mode of the order information is manual synchronization, and in response to that the manual synchronization is performed, the order management module immediately executes the step of synchronizing order information at the time interval T1, storing order information of the e-commerce platform to the e-commerce ERP database each time the order information is synchronized, and displaying latest order information in the order list.

10. A system, comprising:
an order management module configured to execute operation instructions of the order automatic interception method according to claim 1.
